(19) United States
(12) Patent Application Publication
(10) Pub. No.: US 2022/0393748 A1
(43) Pub. Date: Dec. 8, 2022

(54) BEAMFORMING AND POSITIONING REFERENCE SIGNAL TRANSMISSIONS

(71) Applicant: Sony Group Corporation, Tokyo (JP)

(72) Inventors: Johan HILL, Lund (SE); Basuki PRIYANTO, Lund (SE); Rickard LJUNG, Helsingborg (SE)

(21) Appl. No.: 17/761,553

(22) PCT Filed: Oct. 5, 2020
(86) PCT No.: PCT/EP2020/077816

§ 371 Date: Mar. 17, 2022

(30) Foreign Application Priority Data
Oct. 4, 2019 (SE) 1930312-2

(51) Int. Cl. H04B 7/06; G01S 5/00; H04B 7/022; H04B 7/0408; H04W 64/00

(52) U.S. Cl. CPC H04B 7/0695; G01S 5/0036; H04B 7/022; H04B 7/0408; H04B 7/0617; H04B 7/0645; H04W 64/00

(57) ABSTRACT

A method of operating a network node (140) of a network (100) is provided. The network (100) comprising a first access node (191) and at least one second access node (192-195). The method includes establishing a first state of one or more first beams (71-78) of a first transmission between the first access node (191) and a mobile device (90). The method further includes determining whether a certain one of one or more second beams (71-78) of a second transmission between the at least one second access node (192-195) and the mobile device (90) is to be activated, based on the first state and a predetermined mapping (51) between the first state and a second state of the one or more second beams (71-78), the second transmission comprising positioning reference signals (3056).

### TECHNICAL FIELD

Various examples relate to positioning of a mobile device using a transmission of positioning reference signals. Various examples relate to a transmission of the positioning reference signals using beamforming, e.g., transmit beamforming or receive beamforming.

### BACKGROUND

Mobile devices (sometimes also referred to as user equipment; UE) offer various use cases. One use case is wireless communications. A further use case is positioning of the UE.

To facilitate positioning of UEs, multilateration or multriangulation techniques can be employed. An example of multilateration is trilateration. Here, multiple access nodes (AN)—having a well-defined position in a reference coordinate system—transmit positioning signals (also referred to as positioning reference signals, PRSs). A UE can receive the PRSs; then it is possible to perform multilateration or multriangulation. One particular technique is observed time-difference of arrival (OTDOA).

OTDOA is, in particular, deployed in Third Generation Partnership (3GPP) cellular networks, such as the Long Term Evolution (LTE) 4G or New Radio (NR) 5G protocols. Here, the UE may receive PRSs from multiple base stations (BSs) implementing the ANs and then performs a timing difference of arrival (TDOA) measurement. Results of the TDOA measurements are transmitted from the UE to a location server (LS) using a positioning protocol (PP). This is via the 3GPP radio access network (RAN). The LS then performs the positioning estimation based on multilateration and/or multiangulation of at least two or at least three results of the TDOA measurements. See 3GPP Technical specification (TS) 36.305, V15.0.0 (2018 July), section 4.3.2.

To efficiently utilize the electromagnetic spectrum, beamforming can be employed. Here, an antenna array is used to transmit and/or receive (communicate) signals with directivity. For this, multiple antennas of the antenna array are operated in a phase-coherent manner to implement constructive and destructive interference for preferred and non-preferred directions, respectively. Thereby, beams are defined. Then, high carrier frequencies can be used and spatial multiplexing becomes possible.

It has been found that it can be difficult to combine positioning using multilateration and/or multiangulation with beamforming. This is because multiple neighboring ANs of the UE have to communicate PRSs on the appropriate beams. This can make beam management, i.e., the process of selecting the appropriate beam difficult.

### SUMMARY

Accordingly, a need exists for advanced techniques of positioning in combination with beamforming.

This need is met by the features of the independent claims. The features of the dependent claims define embodiments.

A method of operating a network node of a network is provided. The network includes a first access node and at least one second access node. The method includes establishing a first state of one or more first beams. The one or more first beams are of a first transmission. The first transmission is between the first access node and a mobile device. The method also includes determining whether a certain one of one or more second beams of a second transmission is to be activated. The second transmission is between the at least one second access node and the mobile device. Said determining whether the certain one of the one or more second beams is to be activated is based on the first state and a predetermined mapping. The predetermined mapping is between the first state and a second state of the one or more second beams.

The second transmission may include PRSs.

Such method may further include triggering the second transmission in accordance with said determining of whether the certain one of the one or more second beams is to be activated.

A network node executing such method is provided. For example, the network node could include respective control circuitry to execute the method. The network node may be a location server of the network.

A computer program or a computer program product or a computer-readable storage medium includes program code. The program code can be executed by at least one processor. Upon executing the program code the at least one processor can perform a method of operating a network node of a network. The network includes a first access node and at least one second access node. The method includes establishing a first state of one or more first beams. The one or more first beams are of a first transmission. The first transmission is between the first access node and a mobile device. The method also includes determining whether a certain one of one or more second beams of a second transmission is to be activated. The second transmission is between the at least one second access node and the mobile device. Said determining whether the certain one of the one or more second beams is to be activated is based on the first state and a predetermined mapping. The predetermined mapping is between the first state and a second state of the one or more second beams.

A method of operating a network node of a network is provided. The network includes a first access node and at least one second access node. The method includes establishing a first state of one or more first beams. The one or more first beams are of a first transmission. The first transmission is between the first access node and a mobile device. The method also includes determining a second state of one or more second beams of a second transmission. The second transmission is between the at least one second access node and the mobile device. Said determining of the second state is based on the first state and a predetermined mapping. The predetermined mapping is between the first state and the second state of the one or more second beams.

Such method may further include triggering the second transmission in accordance with the second state.

A network node executing such method is provided. For example, the network node could include respective control circuitry to execute the method. The network node may be a location server of the network.

A computer program or a computer program product or a computer-readable storage medium includes program code. The program code can be executed by at least one processor. Upon executing the program code the at least one processor can perform a method of operating a network node of a network. The network includes a first access node and at least one second access node. The method includes establishing a first state of one or more first beams. The one or more first beams are of a first transmission. The first transmission is between the first access node and a mobile device. The method also includes determining a second state of one or more second beams of a second transmission. The second transmission is between the at least one second access node and the mobile device. Said determining of the second state is based on the first state and a predetermined mapping. The predetermined mapping is between the first state and the second state of the one or more second beams.

A method of operating a mobile device that is served by a first access node of a network is provided. The network includes the first access node and at least one second access node. The method includes activating a reporting scheme. The reporting scheme is selected from a plurality of reporting schemes for providing at least one beam report message. The at least one beam report message includes a state of one or more first beams of a first transmission between the first access node and a mobile device. The method also includes providing the at least one beam report message, in accordance with the reporting scheme.

The first access node can be a serving base station of the network. The at least one second access node can be at least one neighboring base station of the network.

A mobile device executing such method is provided. For example, the mobile device could include respective control circuitry to execute the method.

A computer program or a computer program product or a computer-readable storage medium includes program code. The program code can be executed by at least one processor. Upon executing the program code the at least one processor can perform a method of operating a mobile device that is served by a first access node of a network. The network includes the first access node and at least one second access node. The method includes activating a reporting scheme. The reporting scheme is selected from a plurality of reporting schemes for providing at least one beam report message. The at least one beam report message includes a state of one or more first beams of a first transmission between the first access node and a mobile device. The method also includes providing the at least one beam report message, in accordance with the reporting scheme.

A method of operating a mobile device that is served by a first access node of a network is provided. The network includes the first access node and at least one second access node. The method includes obtaining a control command. The control command is obtained from a location server of the network. The control command is indicative of whether a certain one of one or more second beams of a second transmission between the at least one second access node and the mobile device is to be activated. Alternatively or additionally, the control command is indicative of time-frequency resources allocated to the second transmission.

The second transmission may include PRSs.

A mobile device executing such method is provided. For example, the mobile device could include respective control circuitry to execute the method.

A computer program or a computer program product or a computer-readable storage medium includes program code. The program code can be executed by at least one processor. Upon executing the program code the at least one processor can perform a method of operating a mobile device that is served by a first access node of a network. The network includes the first access node and at least one second access node. The method includes obtaining a control command. The control command is obtained from a location server of the network. The control command is indicative of whether a certain one of one or more second beams of a second transmission between the at least one second access node and the mobile device is to be activated. Alternatively or additionally, the control command is indicative of time-frequency resources allocated to the second transmission.

A method of operating an access node of a network is provided. The method includes obtaining a control command from a network node of the network. The control command is to participate in a transmission between the access node and a mobile device. The control command is indicative of whether a certain one of one or more second beams of a second transmission between the at least one second access node and the mobile device is to be activated. Alternatively or additionally, the control command is indicative of time-frequency resources allocated to the second transmission.

The transmission may include positioning reference signals.

The access node may be a serving access node of the mobile device, or may be a neighboring access node of the mobile device. A neighboring access node may generally denote an access node of a cell of a cellular network that is adjacent to a serving cell of the cellular network.

A access node executing such method is provided. For example, the access node could include respective control circuitry to execute the method.

A computer program or a computer program product or a computer-readable storage medium includes program code. The program code can be executed by at least one processor. Upon executing the program code the at least one processor can perform a method of operating an access node of a network. The method includes obtaining a control command from a network node of the network. The control command is to participate in a transmission between the access node and a mobile device. The control command is indicative of whether a certain one of one or more second beams of a second transmission between the at least one second access node and the mobile device is to be activated. Alternatively or additionally, the control command is indicative of time-frequency resources allocated to the second transmission.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a cellular network according to various examples.

FIG. 2 schematically illustrates a location server node according to various examples.

FIG. 3 schematically illustrates a UE according to various examples.

FIG. 4 schematically illustrates a base station according to various examples.

FIG. 5 is a flowchart of a method according to various examples comprising a calibration and a positioning.

FIG. 6 is a flowchart of a method according to various examples illustrating the calibration.

FIG. 7 is a flowchart of a method according to various examples illustrating the positioning.

FIG. 8 is a flowchart of a method according to various examples.

FIG. 9 is a flowchart of a method according to various examples.

FIG. 10 schematically illustrates a mapping between beams of multiple base stations according to various examples.

FIG. 11 is a signaling diagram according to various examples.

FIG. 12 is a signaling diagram according to various examples.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

Hereinafter, techniques of positioning a UE will be described, i.e., of determining the location of the UE. In particular, the positioning can be based on multilateration and/or multiangulation. The positioning can use transmission of PRSs.

The positioning can be implemented by a positioning mesh network or a communications network. For sake of simplicity, various scenarios are described hereinafter with respect to an implementation of the communications network by a cellular network. The cellular network includes multiple cells. Each cell corresponds to a respective sub-area of the overall coverage area. Other example implementations include Institute of Electrical and Electronics Engineers (IEEE) WLAN network, MulteFire, etc.

The positioning described herein generally rely on the transmission of PRSs. As a general rule, downlink (DL) PRS may be used, and/or uplink (UL) PRS may be used. The DL PRSs are transmitted by multiple ANs and can be received by a target UE to be positioned. The ANs can have a well-defined position within a reference coordinate system and the UE can be positioned within the reference coordinate system. Similarly, the UL PRSs are transmitted by the UE to be positioned, and multiple ANs can receive the UL PRSs. A receive property of the PRSs, e.g., time-delay, time difference, time-of-flight, angle of arrival, angle of departure, and/or signal strength—can be measured and the location of the UE can be estimated based on the receive property.

As a general rule, a PRS defines a signal having a well-defined signal shape, e.g., encoding a well-defined bit sequence and/or comprising symbols of appropriate phase and amplitude. A PRS can be used to facilitate positioning. A PRS can be transmitted and/or received (communicated) in well-defined time-frequency resources. Based on a-priori knowledge about the PRS, it is possible to determine the receive property, e.g., amplitude, phase path loss, time-of-travel, and/or angle-of-arrival, etc.

As a general rule, various techniques rely on a location server node (LS) to participate in the positioning. The LS can communicate with, e.g., the ANs and/or the UE using a PP. The LS can determine/estimate the location of the UE based on the receive property of the PRSs. According to the various techniques described herein, the positioning may employ a multilateration and/or multiangulation based on one or more receive properties—e.g., time delay and/or angle of arrival and/or receive strength—of the PRSs. It would be possible that the logic for implementing said positioning partly or fully resides at the UE to be positioned, and/or partly or fully resides at the LS. For example, it would be possible that the UE reports raw measurement data associated with the one or more receive properties of the PRSs to the LS and that the multilateration and/or multiangulation is implemented at the LS. It would also be possible that at least a part of the processing of the multilateration and/or multiangulation etc. is implemented at the UE. The positioning may generally comprise OTDOA.

According to various examples described herein, transmission of the PRSs may be implemented on a wireless link of the cellular network on which also transmission of further signals is implemented. In particular, the further signals may encode, e.g., control messages or payload messages. The wireless link may operate according to a transmission protocol of the cellular network. For example, the transmission protocol may employ Orthogonal Frequency Division Multiplex (OFDM) modulation. Here, a carrier comprises multiple subcarrier and one or more associated time-frequency resource grids are defined. The ANs of the cellular network are referred to as base stations (BSs).

While various scenarios will be described in the context of a cellular network including BSs, similar techniques may be readily applied to other kinds of networks, e.g., positioning mesh networks, etc.

According to various examples, positioning is combined with beamforming. In particular, the BSs transmitting DL PRSs or receiving UL PRSs can employ beamforming. For transmitting DL PRSs, the BSs can use transmit (TX) beamforming. Here, one or more TX beams can be used to transmit the DL PRSs. For receiving UL PRSs, the BSs can use receive (RX) beamforming. Here, one or more RX beams can be used to receive the UL PRSs transmitted by the UE.

To align the antenna port configuration typically affecting spatial transmission profiles (beams) between the BSs and the UE, beam pairs can be established. A first beam pair between a UE and the BS of a cell is typically established during so-called initial access procedure, e.g., the phase of initial cell search procedure where the UE attempts to read and detect synchronization signals (SSs) transmitted by the BS, e.g., in a synchronization signal block (SSB). Several beams of the BS may sequentially transmit the SSB and the UE attempts to acquire the SSs and synchronize to the timing of the BSs based on the SSs. The synchronization is followed by a random access (RA) procedure using the same beam pair. Based on this, the BS has knowledge on a preferred beam pair to start a communication with the UE and vice-versa, e.g., on a data connection established by the RA procedure.

Next, details with respect to the beam management, i.e., the selection of the appropriate beams will be described. The spatial filters (also referred to as antenna weights, defining amplitude and phase relationships between multiple antenna elements of a phased array antenna) used for shaping the beams (analog or digitally) may be used as an initial assumption of the beamforming configuration for the serving BS. The initial beam pair can be refined to give the UE better signal properties with higher antenna gains at later stage. For example, beam sweeps may be implemented in which multiple TX/RX beam pairs are tested, e.g., for UL and/or DL. Also, when a broadcast channel is read—the broadcast channel may also be part of the SSB—the system information can be read. Then, it is possible to detect further signals from the BSs based on the system information and thereby refine the beam pairs by using such other signals than the ones from SSB. The measurements are based on the Non Zero Power Channel State Information-Reference Signal (NZP-CSI-RS) that in many cases will use a narrower beam configuration compared to the beams of a transmission including the SSB.

The measurement of a RX property of the NZP-CSI-RS is reported to the network (measurement report) and can be used to select the DL TX beam. As a general rule, the measurement report as described herein may include raw RX properties, e.g., e.g., delay, amplitude, phase, angle-of-arrival, RSRP (Reference Signal received power) reported per beam pair, time-of-flight, resource-ID, etc. The measurement report could also include derived channel state information in terms of CQI (Channel Quality Indicator), Rank information (RI) and the PMI (Precoder-matrix indicator).

As explained above, NZP-CSI-RS are typically used for beam management to support data communication between UE and serving BS. Positioning, on the other hand is mainly based on PRS. Positioning may be based on reference signal time difference (RSTD) measurements. An example is OTDOA. For this, UL or DL PRSs can be used. As a general rule, the PRSs signals can use one or more symbols that encode a predefined bit sequence. An example would be a gold sequence resource mapped in a diagonal, Comb-N. To localize/position a UE, the PRSs are transmitted along the different paths. Trilateration is used to solve the geo-coordinates of the UE based on the difference in time of flights of the PRSs.

For DL PRSs, the network—e.g., the LS—can command the UE to receive DL PRSs from BSs of a cell list. Measurement reports including RX properties of the DL PRSs are provided back. Based on the measurement reports, the position can be determined. The LS can alternatively or additionally command the UE to transmit UL PRSs.

The DL PRSs are transmitted in time-frequency resource elements on several beams. The DL PRSs time-frequency resources can be scheduled in time domain, e.g., sequentially using different beams for each OFDM symbol or a set of OFDM symbols. Alternatively, DL PRSs time-frequency resources could be scheduled in time domain, but with an immediate repetition per beam—e.g., using same beam for transmission of DL PRSs in two or more OFDM symbols, and only then changing the beam. For BSs that are able to transmit different beams simultaneously, other methods than time domain scheduling would also be possible. For example, scheduling in frequency domain and/or spatial multiplexing can be relied upon.

Various techniques are based on the finding that selection of appropriate TX or RX beams at the BSs for a transmission including PRSs will affect the localization accuracy and positioning latency, as well the amount of system resources that are used and the power consumption of the UE. For instance, it is conceivable that there is a large number of candidate beams per BSs. Thus, to select the appropriate beam or beams from the candidate beams can be a challenging task. The beam management for positioning should be implemented efficiently and fast.

Even further, for positioning it is required to select appropriate beams for multiple BSs. A serving BSs—having an established data connection with the UE—and one or more further non-serving BSs are required to communicate PRSs with the UE. Thus, the complexity of the beam management tends to increase.

It has been found that, typically, a beam management that closely tracks the state of the various beams is primarily available for the serving BS. Here, beam management using a transmission including NZP-CSI-RSs can be employed. An appropriate selection of a beam at the serving BS for PRS transmission may rely on quasi co-location (QCL) with respect to the selection of other beams, e.g., assuming that the state of beams of a first transmission including SSBs or NZP-CSI-RSs correlates with the state of a second transmission including PRSs. A relationship between beams for PRS transmission and beams for other transmissions may be specified in a Transmission Configuration Index (TCI). The TCI can indicate to what extent such beams can be assumed to be quasi co-located. This is based on the finding that beams for the different signals will likely differ, but some relation/correspondence exist. This relation can be utilized by QCL. However, measuring on, e.g., a n SSB transmission and use this information to select beam for PRS may not always be accurate and it's always a risk that not the best beam is chosen when using QCL information. If QLC with SSB is used for PRS, the PRS may be transmitted with wide beams and there will in such case be a risk of bad beam selection since weak PRSs are received. This can result in inaccurate results of positioning.

Also, for BSs of neighbor cells, beam management using a transmission including SSB can be used initially. However, such SSB-based beam management for neighboring BSs faces certain restrictions and drawbacks: The SSB with limited bandwidth size (e.g. 5 MHz) is transmitted repeatedly, but sometimes the flexibility of the UE to measure is limited due to a limited allocation of measurements gaps or limitations in off durations of a discontinuous reception cycle. Thus, such an approach is likely to result in increased latency. To give a typical example: Neighboring cells are measured in so-called inter-frequency measurements. For inter-frequency measurements, in a connected mode, measurement gaps are used. SSBs can be measured at those measurement gaps (and/or other signals). On the other hand, intra-frequency measurements do not have to utilize measurement gaps in the connected mode; but in disconnected mode the intra-frequency measurements can suffer from latency due to the discontinuous reception cycle. To read NZP-CSI-RS, even from intra-cell measurement, it is required to read SSB first, to be able to synchronize with the transmitter. Further, if NZP-CSI-RS are used for each neighboring cell, more time is needed at every measurement gap to get the knowledge of the beams and the RSTD information. This increases the latency and UE power consumption.

If beam sweeping of a transmission including PRSs is used, it can take many PRS resources to identify the beam for each neighboring cell. Again, this may result in increasing positioning latency. Another aspect is that using a bad beam even selection if it is still detected might affect detection latency and even more likely the accuracy.

Accordingly, it is relevant to find a fast, low-overhead beam selection method for selecting a good beam for PRS transmission also for BSs of neighboring cells.

According to various examples, an efficient selection of a beam for a PRS transmission at BSs of neighboring cells (neighboring to the serving cell) is facilitated. Briefly, according to various examples described herein, this is achieved by using a-priori knowledge on appropriate beams at the network. In particular, the a-priori knowledge can take into account a relationship between the serving BS and one or more neighboring BSs. More specifically, correspondences between the beam selection at the serving BS and beam selection at the one or more neighboring BSs may be captured by the a-priori knowledge.

In further detail, for BSs having a fixed position, it has been found that the selection of a first beam for a PRS transmission at the serving BS can correlate with the selection of second beams for a PRS transmission at one or more neighboring BSs. These correlations are utilized according to various examples, to provide for the fast and low-overhead beam selection for beams of a PRSs transmission.

Hereinafter, beams of a transmission to or from the serving BS will be referred to as serving-BS beams. Beams of a further transmission to or from one or neighboring BSs will be referred to as neighboring-BS beams.

According to examples, a first state of one or more serving-BS beams of a first transmission between the serving BS and the UE on the one or more serving-BS beams can be established, e.g., at a network node such as the LS. Then, based on this first state and a predetermined mapping, it is possible to determine a second state of one or more neighboring-BS beams of a second transmission between at least one neighboring BS and the UE on the one or more neighboring-BS beams. Accordingly, the predetermined mapping is between the first state and the second state. The predetermined mapping thus translates the first state into the second state. Then, it is possible to determine whether a certain one of the one or more neighboring-BS beams is to be activated or not, based on the second state. The second transmission can then be triggered in accordance with said determining of the second state of the one or more neighboring-BS-beams. I.e., it is possible to provide a respective control command to the at least one neighboring BS and/or the UE, to indicate at least one of the neighboring-BS beams to be activated and/or indicate at least one of the neighboring-BS beams to be deactivated. Then, a new transmission can be started in accordance with such determining; or an ongoing transmission can be appropriately adjusted. Thus, the second transmission may be the new transmission to be started in accordance with the determining of the second state. In other embodiments the second transmission is the ongoing transmission to be appropriately adjusted in accordance with said determining of the second state.

The first transmission, as well as the second transmission can include PRS. In some examples, it would also be possible to establish the first state of the one or more serving-BS beams based on the first transmission including other signals, e.g., SSB or CSI-RS. This corresponds to QCL.

As a general rule, the techniques described herein can be applicable to DL PRS transmitted by the BSs. Here, states of TX beams on which the DL PRS are transmitted can be subject to the described techniques. Alternatively or additionally, the techniques described herein can be applicable to UL PRS received by the BSs. Here, states of RX beams on which the UL PRS are received can be subject to the described techniques.

The states of beams can generally denote, e.g., whether a beam is currently active or used (activity) or the communication quality on the respective beam (e.g., using a measurement report). The communication quality could specify, e.g., a receive strength or a time-of-flight on the respective beam. The communication quality could describe a fading strength and/or a path loss, to give just a few examples. As a general rule, the state of beams can dynamically vary. For instance, as the UE moves, the state of beams can change. Differently, a beam configuration, e.g., direction of the beam, beam width, etc., may be comparably static.

There are various options available regarding how to establish the states of the beams. For instance, one or more beam report messages may be provided by the serving BS and/or the UE, the one or more beam report messages being indicative of the first state of the one or more first PRS beams. As a general rule, beam report messages may be transmitted using a PP. For instance, if the activity of the serving-BS beams at the serving BS is relied upon, it may be sufficient for the serving BS to provide the one or more beam report messages; the UE may not be required to provide any beam report messages. Similarly, in case the first state of the one or more serving-BS beams is indicative of a measurement report for the first transmission on the one or more serving-BS beams including UL reference signals, it is possible that the one or more beam report messages are provided by the serving BSs; again, the UE may not be required to provide any beam report messages. For scenarios in which the first state is indicative of a measurement report for the first transmission on the one or more serving-BS beams including DL reference signals, the UE may provide the measurement report that is indicative of at least one receive property of the DL reference signals measured at the UE, e.g., signal strength, angle of arrival, transmission delay, and/or other values. It is conceivable that beam report messages are provided by both the UE and the serving BS.

The predetermined mapping may generally correspond to an a-priori knowledge on the correlation between the one or more serving-BS beams and the one or more neighboring-BS beams. The predetermined mapping could be implemented by a look-up table. The predetermined mapping could look as illustrated by the following tables.

TABLE 1
Example mapping

| Serving-BS beam | Neighboring-BS beam | Neighboring-BS beam |
|---|---|---|
| (activity) | BS-A (activity) | BS-B (activity) |
| 1 | 2, 3 | 3 |
| 2 | 2, 3 | 2 |
| 3 | 1 | 1 |

Table 1 illustrates an example in which the predetermined mapping is between serving-BS beams and neighboring-BS beams. For example, if serving-BS beam 2 is active, then neighboring-BS beams 2 and 3 of BS-A are to be activated; and neighboring-BS beam 2 of BS-B is to be activated.

TABLE 2
Example mapping

| | Neighboring-BS beam | Neighboring-BS beam |
|---|---|---|
| Serving-BS beam | (BS A) | (BS B) |
| 1, RSRP(s-BS-b1) > 5 | 2 | 3 |
| 1, RSRP < 5 | 2, 3 | 3 |
| 2, RSRP > 2 | 2, 3 | 2 |
| 3, RSRP < 2 | 2 | 2, 1 |
| 3 | 1 | 1 |

Table 2 illustrates an example in which the RSRP is also taken into account by the mapping. RSRP is just one example; and other properties of the state of the beams could be taken into account.

The mapping could also be between RSRP. For instance, a parameterized dependency of RSRPs could be specified by the mapping:

RSRP(beam 1 of neighboring−BS A)=α1RSRP(beam 1 of serving BS)^{β1}+α2RSRP(beam 2 of serving BS)^{β2}

The parameterization and the underlying function are simple examples and can vary in other implementations.

As a general rule, such mappings as described above or further mappings described herein can further depend on, e.g., the beam configuration and/or properties of the UE, e.g., geolocation of the UE and/or mobility of the UE (velocity, heading, etc.).

The mapping could also be implemented by a machine-learning algorithm. For instance, the mapping could be implemented by a neural network, e.g., a convolutional neural network. The neural network may receive, as an input, the state of the serving-BS beams, e.g., activity and/or RSRP, etc. The neural network may provide, as an output, the state of the neighboring-BS beams, e.g., activity and/or RSRP, etc. The machine-learning algorithm can accept further inputs, beyond the state of the serving-BS beams. Examples of further inputs include, e.g., UE geolocation or mobility (e.g., velocity, heading, etc.), beam configuration of the beams, etc. Corresponding inputs to the machine-learning algorithm can be collected, e.g., by the LS.

Such techniques utilize the typically accurate and up-to-date knowledge on the appropriate one or more serving-BS beams for the first transmission between the serving BS and the UE (available due to beam management that closely tracks the state of the serving-BS beams): this knowledge is leveraged also for the selection of the one or more neighboring-BS beams at the one or more neighboring BSs. For instance, this makes it possible to leverage the accurate results from NZP-CSI-RS measurement reports available at the serving BS also for the selection of neighboring-BS beams of a transmission of PRSs at a neighboring BS.

As a general rule, there are various options available to obtain the prior knowledge. In other words, there are various options available for determining the mapping. For instance, the mapping may be determined based on calculations, numerical simulations, and/or measurements. To give an example, it would be possible that the mapping is determined based on the geographical locations of the serving BS and the one or more neighboring BSs, e.g., with respect to each other. An orientation of the antennas of the BSs may be taken into account. The calculations could also take into account the configuration of the respective beams. The configuration may include: a beam direction; a transmission power threshold; a time of flight; an angle of arrival; and an angle of departure of the respective beam. Thereby, based on calculations, it is possible to determine the mapping. It would also be possible to simulate beam propagation through the environment and determine the mapping based on such simulations. For instance, such simulations could take into account reflections at obstacles, e.g., high-rise buildings, mountains, etc. Yet another option relies on reference measurement reports obtained from the serving BS and the one or more neighboring BSs. For instance, pairs of reference measurement reports could be relied upon: these pairs of reference measurement reports could indicate that pairs of a serving-BS beam and a neighboring-BS beam show favorable or bad states contemporaneously, i.e., that there is a correspondence/correlation between the states.

By such techniques it becomes possible to reduce the control signaling between the network and the UE. The UE power consumption can be reduced. More specifically, according to various examples, a reduced reporting scheme for providing beam report messages can be implemented.

For example, an extended reporting scheme may require the UE to provide multiple or lengthy beam report messages. The beam report messages of such extended reporting scheme may be indicative of states of multiple beams on which DL reference signals are transmitted by multiple BSs which may be required to support multi-lateration positioning estimation. For instance, beam report messages indicative of the states of neighboring-BS beams may be required. Accordingly, such beam report message that is configured in accordance with the extended reporting scheme can be large in size and require significant bandwidth for the associated control signaling. Also, the measurements required at the UE to determine the states of the beams can cause a significant power consumption at the UE and shortening the positioning measurement process. Thus, according to various examples, it is possible to implement the reduced reporting scheme. Here, for the reduced reporting scheme, the UE may provide beam report messages more often or even exclusively for the serving-BS beams (and less often or not at all for the neighboring-BS beams). This reduces the bandwidth required for the associated control signaling. Further, the UE may not be required to implement measurements for the neighboring-BS beams; thus, the UE is relieved of the associated processing tasks which can reduce the power consumption. In some examples, it would even be possible to implement an ultra-reduced reporting scheme. Here, the UE may not be required to provide any beam report messages or may only be required to provide beam report messages at a comparably low repetition rate (if compared to the above-identified extended reporting scheme and the above-identified reduced reporting scheme). Such scenarios may, in particular, be applicable to cases in which the serving BS is able to provide the beam report message indicative of, e.g., an activity of the one or more RX beams or measurement report of the one or more first RX beams.

According to various examples, the UE can select an appropriate reporting scheme from a plurality of reporting schemes for providing at least one beam report message. Then, the at least one beam report message can be provided in accordance with the selected reporting scheme.

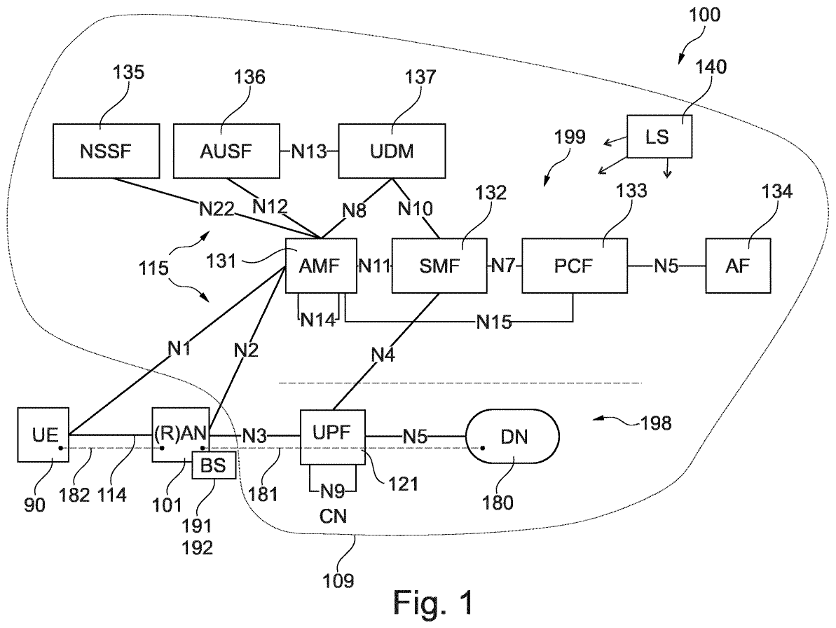

FIG. 1 schematically illustrates a cellular network 100 that may be employed in the various examples described herein. The example of FIG. 1 illustrates the network 100 according to the 3GPP NR 5G architecture. Details of this architecture are described in 3GPP TS 23.501, version 1.3.0 (2017 September). While FIG. 1 and further parts of the following description illustrate techniques in the 3GPP 5G framework of a cellular network, similar techniques may be readily applied to other communication protocols and communications networks. Examples include 3GPP LTE 4G—e.g., in the MTC or NB-IOT framework—and even non-cellular wireless systems, e.g., an IEEE Wi-Fi technology. It is even possible to apply the techniques described herein outside of communication networks, e.g., for positioning mesh networks.

In the scenario of FIG. 1, a UE 90 is connectable to the cellular network 100. For example, the UE 90 may be one of the following: a cellular phone; a smart phone; and IOT device; a MTC device; etc. The UE 90 may be stationary or non-stationary.

The UE 90 is connectable to the network 100 via a RAN 101, typically formed by one or more BSs 191, 192. The BS 191 is assumed to be serving the UE 90. The BS 192 is a neighboring BS. A wireless link 114 is present between the RAN 101—specifically between one or more of the BSs 191, 192 of the RAN 101—and the UE 90. The wireless link 114 may include multiple spatial propagation channels that can be selectively addressed by beamforming, i.e., different beams.

The RAN 101 is connected to a core network (CN) 109. The CN 109 includes a user plane (UP) 198 and a control plane (CP) 199. Application data is typically routed via the UP 198. For this, there is provided a UP function (UPF) 121. The UPF 121 may implement router functionality. Application data may pass through one or more UPFs 121, along a CN tunnel 181. In the scenario of FIG. 1, the UPF 121 acts as a gateway towards a data network 180, e.g., the Internet or a Local Area Network. Application data can be communicated between the UE 90 and one or more servers on the data network 180.

The network 100 also includes an Access and Mobility Management Function (AMF) 131; a Session Management Function (SMF) 132; a Policy Control Function (PCF) 133; an Application Function (AF) 134; a Network Slice Selection Function (NSSF) 134; an Authentication Server Function (AUSF) 136; and a Unified Data Management (UDM) 137. FIG. 1 also illustrates the protocol reference points N1-N22 between these nodes.

The network also includes a LS 140. While in the scenario of FIG. 1 the LS 140 is implemented in the control plane 199, there are options to implement the LS 140 in the user plane 198. The LS 140 could also be co-located with a BS 191, 192. The LS 140 can communicate with the various nodes of the network 100 using a PP (e.g., in 3GPP LTE with the UE 90, see 3GPP TS 36.355; with the BS 191, 192, see 3GPP TS 36.455; and with the Mobility Management Entity, see 3GPP TS 29.171). The LS 140 is configured to control and assist in positioning of the UE 90. The LS 140 is sometimes referred to as Location Management Function (LMF). The LS is sometimes referred to extended Serving Mobile Location Center (E-SMLC).

The AMF 131 provides one or more of the following functionalities: registration management; Non-Access Stratum termination; connection management; reachability management; mobility management; access authentication; and access authorization.

A RAN connection 182 may be established between the UE 90 and the RAN 101, more specifically the serving BS 191. For example, the RAN connection 182 may include a signal radio bearer (SRB) and/or a data radio bearer (DRB). The SRB can be mapped to the common control channel of the wireless link 114 during establishment of the RAN connection; upon establishment of the RAN connection, a dedicated control channel of the wireless link 114 may be set-up. For example, RRC control signaling may be implemented on the SRB. The DRB may be used for payload data such as application layer data. This RAN connection 182 is characterized by a UE context information, e.g., defining security parameters, beam reporting schemes, etc.

The SMF 132 provides one or more of the following functionalities: session management including session establishment, modify and release, including tunnel setup of CN tunnels 181 between the RAN 101 and the UPF 121; selection and control of UPFs; configuring of traffic steering; roaming functionality; termination of at least parts of NAS messages related to session management; etc. As such, the AMF 131 and the SMF 132 both implement CP management needed to support a moving UE.

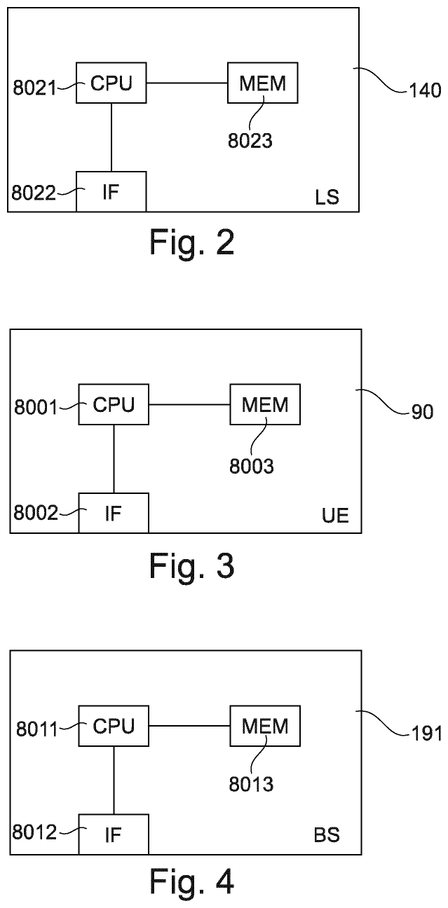

FIG. 2 illustrates aspects with respect to the LS 140. The LS 140 includes a processor 8021 and a memory 8023. The processor 8021 and the memory 8023 implement a control circuitry. For example, the processor 8021 could load program code from the memory 8023 and then execute the program code. Based on execution of the program code, the processor 8021 could perform one or more of the following logic operations: establishing a state of beams at one or more BSs 191, 192, e.g., by receiving one or more beam report messages via an interface 8022, e.g., using a PP; applying a state of beams at a first BS to a predetermined mapping, to thereby obtain a further state of further beams at one or more second BSs; trigger transmission in accordance with the further state of the further beams; perform positioning, e.g., in accordance with OTDOA; configure a reporting scheme for providing beam report messages at the UE 90 and/or the BSs 191-192; etc.

FIG. 3 illustrates aspects with respect to the UE 90. The UE 90 includes a processor 8001 and a memory 8003. An interface 8002 can be used to communicate with other nodes of the network 100. The interface 8002 may, in particular, include a modem for wireless communication on the wireless link 114. The processor 8001 and the memory 8003 implement a control circuitry. For example, the processor 8001 could load program code from the memory 8003 and then execute the program code. Based on the execution of the program code, the processor 8001 could perform one or more of the following logic operations: selecting a beam reporting scheme for providing beam report messages; providing beam report messages in accordance with the selected beam reporting scheme; providing measurement reports of received DL PRSs to a LS using a PP, to facilitate positioning; receiving the DL PRSs from a serving BS and one or more neighboring BSs; transmitting UL PRSs to a serving BS and one or more neighboring BSs; participate in positioning techniques; etc.

FIG. 4 illustrates aspects with respect to the BS 191. Further BSs such as BS 192 can be configured like. The BS 191 includes a processor 8011 and a memory 8013. The BS 191 also includes an interface 8012. The interface 8012 can include a modem for communicating on the wireless link 114. The processor 8011 and the memory 8013 implement a control circuitry. For example, the processor 8011 could load program code from the memory 8013 and then execute the program code. Based on the execution of the program code, the processor 8011 could perform one or more of the following logic operations: participating in positioning techniques; transmitting DL PRSs on one or more TX beams; receiving UL PRSs on one or more RX beams; providing a beam report message to the LS 140, e.g., using a PP, the beam report message being indicative of a state of one or more beams of a transmission between the BS 191 and the UE 90; configuring a transmission including UL or DL PRSs in accordance with a state indicated by the LS 140, e.g., in a corresponding control message; etc. An interface 8012 of the BS 191 can be used to communicate on the wireless link 114 and/or with the CN109.

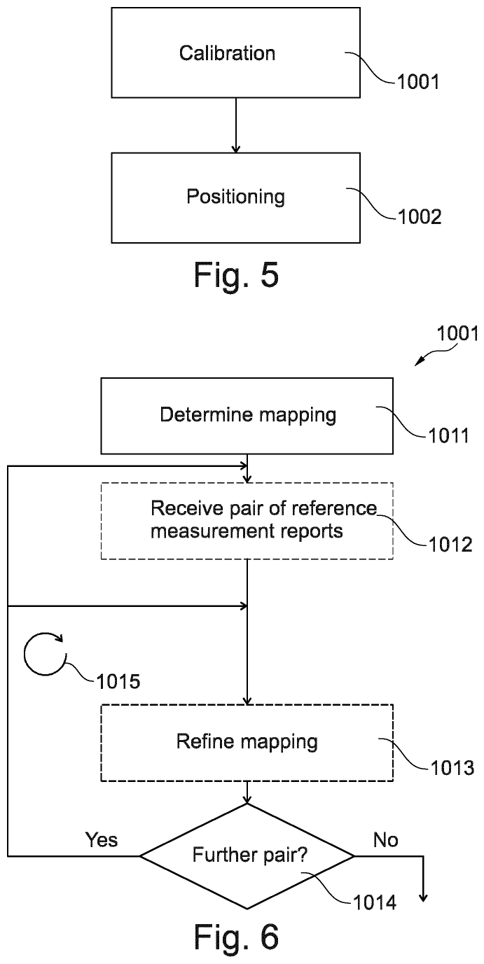

FIG. 5 is a flowchart of a method according to various examples. For instance, the method of FIG. 5 may be executed by the LS 140, more specifically, the processor 8021 upon loading program code from the memory 8023. In other examples, the method of FIG. 5 may be executed by other devices or nodes of the network 100.

At box 1001, a calibration is executed. The calibration can be used to acquire prior knowledge on correspondences between serving-BS beams of a first transmission between the serving BS 191 and the UE 90 and neighboring-BS beams of a second transmission between one or more neighboring BSs 192 and the UE 90. For instance, it would be possible to determine a mapping from the serving-BS beams to the neighboring-BS beams as part of box 1001. More specifically, the mapping can specify a-priori knowledge on the behavior of the neighboring-BS beams as a function of behavior of the serving-BS beams.

As a general rule, the mapping can include one or more of a look-up table, a parameterized dependency, and a machine-learning algorithm. along with such varying options for the implementation of the mapping, the calibration can vary. For instance, in case of a machine-learning algorithm, the calibration can include a training phase. Here, based on historical knowledge—e.g., pairs of reference measurement reports—a neural network may be trained using backpropagation, to give just one example. To implement the training, it is possible to collect respective data, e.g., from the UE and/or the various BSs 191, 192. A respective data collection mode may be activated in which respective reporting is provided.

Next, at box 1002, positioning is executed. The positioning at box 1002 can determine a location/position of the UE 90. For this, PRS, e.g., UL PRS and/or DL PRS can be communicated in respective transmissions. These transmissions, in particular between the UE 90 and one or more neighboring BSs 192, can rely on the prior knowledge collected at box 1001. For instance, it would be possible to determine a state of the neighboring-BS beams based on the mapping determined at the calibration of box 1001.

As will be appreciated from FIG. 5, the calibration of box 1001 may precede the actual positioning at box 1002. In some examples, it would be possible to re-execute calibration from time to time, by re-executing box 1001.

Next, details with respect to the calibration of box 1001 will be explained in connection with FIG. 6.

FIG. 6 is a flowchart of a method according to various examples. For instance, the method of FIG. 6 may be executed by the LS 140, more specifically, the processor 8021 upon loading program code from the memory 8023. In other examples, the method of FIG. 6 may be executed by other devices and nodes of the network 100.

The method of FIG. 6 may implement the calibration at box 1001 according to FIG. 5.

Optional boxes are shown with dashed lines.

FIG. 6 illustrates a 2-step scenario for obtaining the mapping. Such a 2-step scenario is generally optional. In other examples, a 1-step scenario for obtaining the mapping would also be feasible.

At box 1011, the mapping is determined. There are various options conceivable for implementing box 1011.

For instance, it would be possible that the mapping is determined based on geo-locations of the serving BS 191 and one or more neighboring BSs 192.

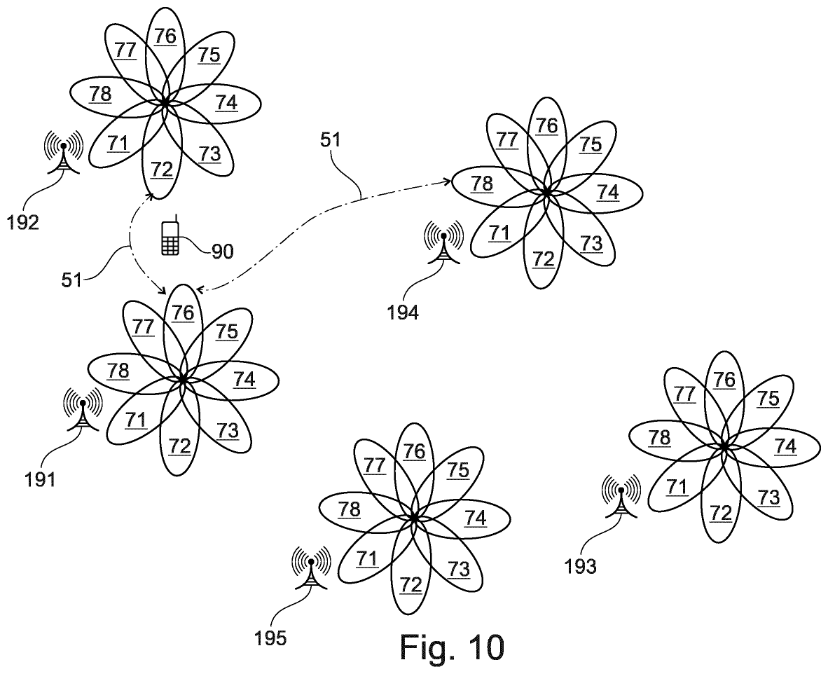

For illustration, based on knowledge on the geo-locations of the various BSs 191, 192, it would be possible—e.g., under the assumption of line-of-sight propagation—to determine orientations of beams, based on intersecting areas in which beams from different ones of the multiple BSs 192, 192 overlap. This is also illustrated in FIG. 10 below.

A further option for determining the mapping at box 1011 relies on using a configuration of the one or more serving-BS beams and/or the one or more neighboring-BS beams. The configuration of the beam can define static or semi-static characteristics of that beam. Sometimes, there may be a predefined finite set of beams, defined by a codebook. Each beam of the set of beams can be associated with corresponding antenna weights used for transmitting or receiving, respectively. Then, the configuration could correspond to these antenna weights or certain derived values. Furthermore, each beam of the set of the beams can be associated with corresponding time/frequency resources of the PRS transmission. Then, the configuration could correspond to these resources. For instance, the configuration could include one or more of the following: a beam direction; a transmission power threshold; an angle of arrival; and an angle of departure.

To give an example, the intersecting areas may depend on the geo-locations and the orientation/beam direction of the beam. A transmission power threshold may intrinsically limit the maximum range of the transmission along a corresponding beam. Path loss and distances between BSs can be considered.

At box 1011, it would also be possible to take into account reference measurement reports for reference transmission on multiple reference serving-BS beams of the serving BS in-between the serving BS and the UE, as well as for a further reference transmission on multiple neighboring-BS reference beams in-between at least one neighboring BS and the UE. Thereby, a measurement of the correspondences between the serving-BS beams and the neighboring-BS beams can be obtained. For instance, if at a given point in time it is determined that the receive strength of a first reference transmission along a reference serving-BS beam is strong, it can be checked for which reference neighboring-BS beam of the second reference transmission there also a strong receive strength at the same given point in time. Based on such a match, the correspondences can be revealed, and the mapping can be determined.

As a general rule, the multiple reference beams may coincide with the beams used for the subsequent positioning at box 1002. In other examples, the reference beams may be different from the beams used for positioning 1002. QCL can be employed.

Box 1011 may also use machine learning techniques, e.g., to infer the correspondences between the beams using a machine-learning algorithm that has been trained to operate on the pairs of the reference measurement reports using historical data, such as past measurement reports, measurement from multiple UEs, etc. For example, a training of a neural network may be implemented in box 1011; this facilitates artificial intelligence.

In some examples, it may be desirable to determine the mapping at box 1011 initially without relying on the reference measurement reports. A reason could be that there is a significant number of candidate pairs of reference measurement reports, because of the significant number of neighboring BSs, as well as the significant number of beams per BS. For this reason, such a measurement-based initial determination of the mapping can be lengthy. To avoid a cold-start problem, it may thus be desirable to proceed initially based on calculations, e.g., based on the geo-locations of the BSs 191, 192, and/or configurations of the beams. In such a scenario, it would be possible to subsequently iteratively refine the mapping based on the reference measurement reports. This would correspond to a two-step approach for obtaining the mapping, as mentioned above. Such a scenario is illustrated in FIG. 6 in accordance with boxes 1012-1014.

At box 1012, a reference measurement report or multiple reference measurement reports are received. These reference measurement reports are for transmissions on reference serving-BS beams between the serving BS 191 and the UE 90, as well as for a further reference transmission on reference neighboring-BS beams between the one or more neighboring BSs 192 and the UE 90.

Then, based on a pair of such measurement reports—pertaining to substantially contemporaneous reference measurements on a reference serving-BS beam and the reference neighboring-BS beam, i.e., at a given point in time at time duration during which mobility of the UE 90 is low—it is possible to refine the mapping at box 1013. I.e., the initially determined mapping can be adjusted, taking into account the measurement. The initially determined mapping can serve as a baseline and a deviation may be considered. For example, in case of a neural network, re-training can be implemented. For instance, if the reference measurement reports are received from time to time, reinforcement learning would be conceivable.

At box 1014, can be checked whether a further pair of reference measurement reports is available. If yes, the box 1013 is re-executed (or, if the respective reference measurement reports are required to be received, box 1012 and 1013 are re-executed). A corresponding loop 1015 is illustrated.

As will be appreciated, such a strategy corresponds to iteratively refining the mapping based on multiple instances of the reference measurement reports, e.g., over the course of time as the location of the UE 90 changes. In such a scenario, it is in particular possible to at least partially execute box 1001 and box 1002 in parallel (cf. FIG. 5).

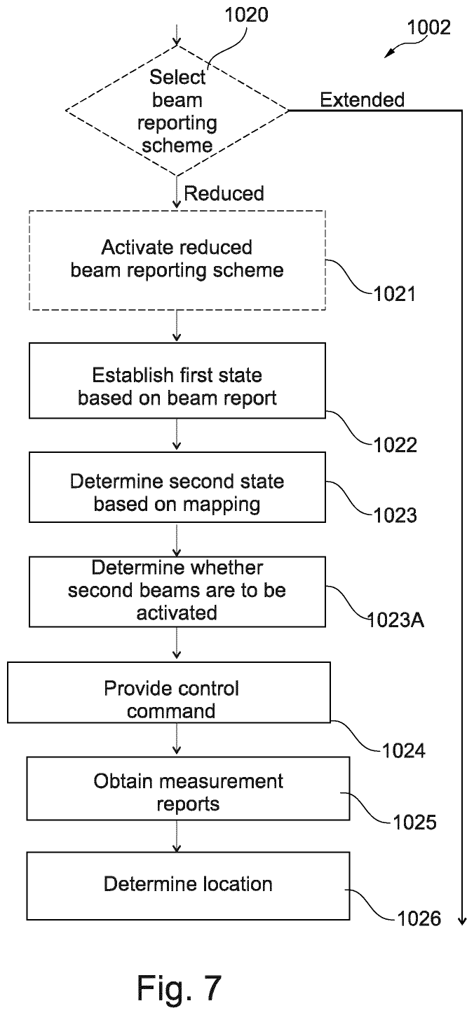

Next, details with respect to the positioning of box 1002 (cf. FIG. 5) are explained below, in connection with FIG. 7.

FIG. 7 is a flowchart of a method according to various examples. For instance, the method of FIG. 7 could be executed by the LS 140, e.g., by the processor 8021 upon loading program code from the memory 8023.

The method of FIG. 7 can implement box 1002 of FIG. 5.

Optional boxes are shown with dashed lines.

At optional box 1020, a beam reporting scheme is selected, e.g., from a plurality of predefined beam reporting schemes.

As a general rule, the beam reporting schemes may define a context of how the UE 90 provides at least one beam report message using a PP. For example, the beam reporting schemes could specify how often or at which repetition rate beam report messages are provided. The beam reporting schemes could also specify the information content of the beam report messages.

In particular, the plurality of beam reporting schemes could include an extended beam reporting scheme and one or more reduced beam reporting scheme. The information content of the beam report messages can be restricted for the one or more reduced beam reporting scheme if compared to the extended beam reporting scheme. It would even be possible to deactivate provisioning the beam report messages altogether for at least one of the one or more reduced beam reporting schemes, e.g., for an ultra-reduced beam reporting scheme.

In one example, the restricted beam reporting scheme can be restricted to providing beam report messages including a first state of the one or more serving-BS beams of a first transmission between the UE 90 and the serving BS 191; i.e., beam report messages may not be provided for the states of neighboring-BS beams of a second transmission between the UE 90 and one or more neighbouring BSs 192. On the other hand, such beam report messages for the neighboring-BS beams may be provided when operating in accordance with the extended beam reporting scheme.

According to some examples, there could be an ultra-reduced beam reporting scheme in which the UE 90 does not provide any beam report messages or only provides the beam report messages restricted to the first transmission at an even lower repetition rate if compared to the reduced beam reporting scheme described above.

If, at box 1020, the extended beam reporting scheme is selected, then reference techniques of positioning can be employed that are not described in further detail (right side branch in FIG. 7).

If, however, at box 1020, a reduced beam reporting scheme is selected, then the method commences at box 1021.

At box 1021, the selected reduced beam reporting scheme is activated. This can include transmitting a respective control message to the UE 90, the control message instructing the UE 90 to activate the selected reduced beam reporting scheme.

Next, at box 1022, the first state of one or more serving-BS beams of the first transmission between the UE 90 and the serving BS 191 is established. This can be based on one or more beam report messages that are obtained in accordance with the selected reduced beam reporting scheme. The one or more beam report messages may be at least partially provided by the UE 90. The one or more beam report message may alternatively or additionally be at least partially provided by the serving BS 191.

For instance, the first state could be indicative of an activity of the one or more serving-BS beams, i.e., whether certain serving-BS beams are activated or not. Alternatively or additionally, the beam report message may also be indicative of a measurement report for the first transmission on the one or more serving-BS beams.

Then, at box 1023, a second state of the one or more neighboring-BS beams of a second transmission between the at least one neighboring BS 192 and the UE 90 on the one or more neighboring-BS beams is determined. This is based on the first state established at box 1022, and further based on the mapping, as previously determined in box 1001. Thus, the mapping is between the first state and the second state.

At box 1023A, it is then determined whether a given one of the neighboring-BS beams is to be activated or is to be deactivated. For example, it would be possible, for each neighboring-BS beam, to determine whether the respective beam is to be activated or deactivated. This determination is based on the second state determined at box 1023A.

As a general rule, it is optional that the determination of whether a given 1 of the neighboring-BS beams is to be activated or is to be deactivated is executed by the LS 140. As such, box 1023A is optional. In some examples, it would be possible that the LS 140 triggers the positioning measurement based on the determined state of the one or more neighboring-BS beams as determined in box 1023. In other words, the LS 140 could inform, e.g., the neighboring-BS(s) 192 and/or the serving BS 191 of the second state; then, the determination of whether a given one of the neighboring-BS beams is to be activated or is to be deactivated could be made at the neighboring-BS 192 and/or the serving BS 191. Thus, in some examples, it would thus be possible that the second state is reported to the serving-BS and then the serving-BS directly informs other neighboring BSs on the selection of which beam to activate or deactivate. Then box 1023A is essentially executed by the serving-BS or a serving-BS with similar LS functionality.

There are various decision criteria conceivable to be considered in box 1023A: For instance, it would be possible to determine to activate such beams that are associated with an RSRP that is expected to be above a threshold. For instance, it would be possible to determine only one strongest beam.

While, in FIG. 7, box 1023 and box 1023A are shown separately, there are scenarios conceivable in which these boxes are implemented together. For example, it would be conceivable that the output of the mapping directly indicates whether a certain neighboring-BS beam is to be activated. Then, there is no separate implementation of box 1023A required.

In some examples, it would even be possible that the second state is reported to the neighboring-BSs and that the neighboring BSs then make the selection of which beam to activate or deactivate. Then box 1023A is not required to be executed by the LS. Then, at box 1024, the second transmission is triggered in accordance with the second state of the one or more neighboring-BS beams. This can include providing a control command to the at least one neighboring BS 192 and/or the UE 90. The control command can be indicative of the state of the one or more neighboring-BS beams, e.g., their activity (whether they are switched on or off) or their expected quality.

Based on the control command, the neighboring-BS can then implement the transmission. For instance, in a scenario in which the control command indicates multiple neighboring-BS beams that are to be activated, the neighboring-BS could select one or more neighboring-BS beams and activate those, or simply activate all neighboring-BS beams.

The second transmission can, as a general rule, include UL PRSs and/or DL PRSs.

At box 1025, measurement reports are obtained for the second transmission. The measurement reports are indicative of a receive property of the UL PRSs and/or the DL PRSs. Then, at box 1026, the location of the UE 90 can be determined based on the measurement reports.

The UL PRSs and/or the DL PRSs are transmitted in accordance with the second setting of the one or more neighboring-BS beams of the second transmission. Accordingly, accurate positioning at box 1026 is facilitated.

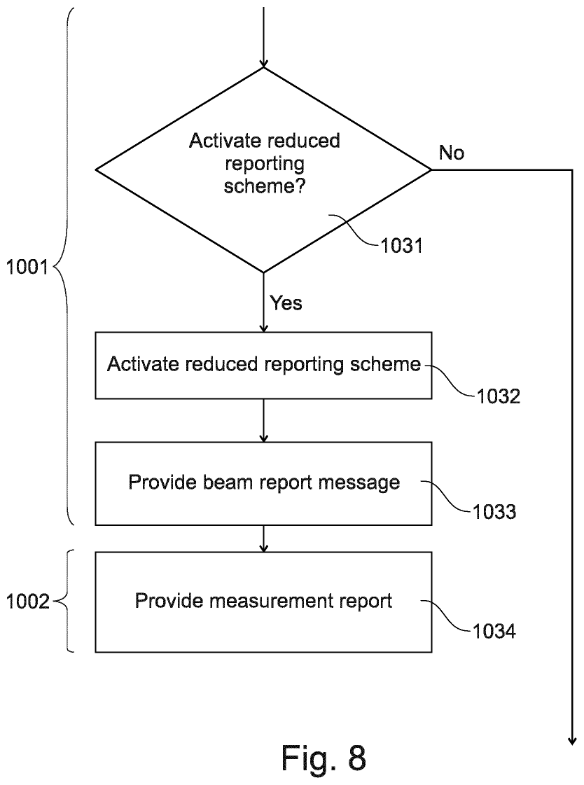

Next, details with respect to the UE behavior will be described, in connection with FIG. 8. The UE behavior is inter-related to the LS behavior explained above, as well as to the BS behavior that will be explained further below.

FIG. 8 is a flowchart of a method according to various examples. The method of FIG. 8 can be executed by a mobile device, e.g., the UE 90 of FIG. 1.

At box 1031, it is checked whether a reduced reporting scheme is to be activated. For example, this check could be based on a control message provided by the LS 140 (cf. FIG. 7: box 1021), e.g., using the PP.

As a general rule, the control message could be indicative of properties of the reduced reporting scheme. For instance, the control message could indicate a identifier of the reduced reporting scheme. The control message could indicate one or more parameters of the reduced reporting schemes, e.g., for which transmissions the states of the respective beams is to be reported, the reporting repetition rate, etc.

If the reduced reporting scheme is not to be activated, then reference implementations of a positioning technique can commence that are not described herein (right side branch in FIG. 8).

Otherwise, if the reduced reporting scheme is to be activated, the method commences at box 1032. At box 1032, the reduced reporting scheme is activated. For example, this can include setting a transmission schedule of beam report messages accordingly. For example, this can include setting an information content of the beam report messages accordingly.

In particular, beam report messages according to the reduced reporting scheme may be transmitted less often and/or with reduced information content, if compared to an extended reporting scheme.

For example, the reduced reporting scheme can include providing beam report messages that are restricted to a first state of the one or more serving-BS beams of a first transmission between the serving BS 191 of the UE 90. A second state of one or more neighboring-BS beams of a second transmission between the neighboring at least one BS 192 and the UE 90 may not be included in the beam report messages. This may be different for the extended beam reporting scheme.

At box 1033, the beam report messages then provided in accordance with the reduced beam reporting scheme (cf. FIG. 7: box 1022). Thus, the information content may be accordingly restricted and/or the timing schedule of the beam report message may be accordingly reduced. This can help to reduce the UE power consumption. The control signaling overhead can be reduced and facilitate low-latency positioning.

It is also possible to reduce or deactivate measurements of the states of the neighboring-BS beams accordingly.

At box 1034, a measurement report on DL PRSs received on the one or more neighboring-BS beams of the second transmission can be provided to the LS 140. The measurement report may be triggered by a respective control command (cf. FIG. 7: box 1024). This facilitates determining the position of the UE 90 at the LS 140 (cf. FIG. 7: box 1025 and box 1026).

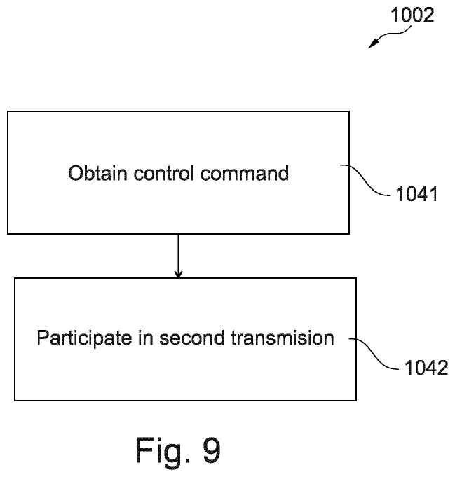

Next, details with respect to the behavior of the at least one neighboring BS 192 will be explained in connection with FIG. 9.

FIG. 9 is a flowchart of a method according to various examples. The method of FIG. 9 can be executed by an AN, e.g., by a BS such as the BS 192 (cf. FIG. 1). The BS executing the method of FIG. 9 can implement a neighboring-BS.

At box 1041, a control command is obtained from the LS 140. The control command instructs the BS 192 to participate in the second transmission between the BS 192 and the UE 90 in accordance with the second state of one or more neighboring-BS beams of the second transmission. This second state can be indicated by the control command (cf. FIG. 7, box 1024). The control command can indicate one or more neighboring-BS beams to be activated.

Next, at box 1042, the BS 192 participate in the second transmission in accordance with the second state of the one or more neighboring-BS beams of the second transmission, e.g., TX and/or RX neighboring-BS beams. More specifically, the BS can use the indication of the control command to activate and deactivate beams.

FIG. 10 schematically illustrates aspects with respect to positioning of the UE 90 according to various examples. FIG. 10 is a schematic illustration of the geolocation of the BS 191 and the geolocation of the BS 192, as well as of the geo-locations of further neighboring BSs 193-195. FIG. 10 also schematically illustrates the geolocation of the UE 90.

As illustrated in FIG. 10, each one of the BSs 191-195 has a number of beams 71-76 available. The beams 71-76 are configured differently. For example, their orientation differs. Accordingly, at different points in time different ones of the beams 71-76 may be activated. For example, at different points in time the transmission quality associated with communication along the various beams 71-76 may vary. In other words, the state of the various beams 71-76 may vary.

In the example of FIG. 10, it would be conceivable to transmit DL PRSs of a transmission between the BS 191 and the UE 90 along a TX serving-BS beam 76; and to transmit DL PRSs of a transmission between the neighboring BS 192 and the UE 90 along the TX neighboring-BS beam 72, and to transmit DL PRSs of a transmission between the neighboring BS 194 and the UE 90 along the TX neighboring-BS beam 78. The remaining beams for each one of the BSs 191, 192, and 194 may be deactivated.

Accordingly, it would be possible that the mapping 51 (dashed-dotted line in FIG. 10) maps the TX serving-BS beam 76 of the transmission from the serving BS 191 to UE 90 to the TX neighboring-BS beam 72 of the transmission from the neighboring BS 192 to the UE 90, as well as to the TX neighboring-BS beam 78 of the transmission from the neighboring BS 194 to the UE 90. These are positive correspondences between the various beams.

The mapping may, as a general rule, include positive and negative correspondences. The mapping may hence also be indicative of the TX neighboring-BS beams 71-78 of of the BSs 193, 195 being deactivated. The mapping may also be indicative of the TX neighboring BS beams 71, 73-78 of the transmission between the BS 192 and the UE 90 being deactivated, and so on. (These negative correspondences are not illustrated in FIG. 10).

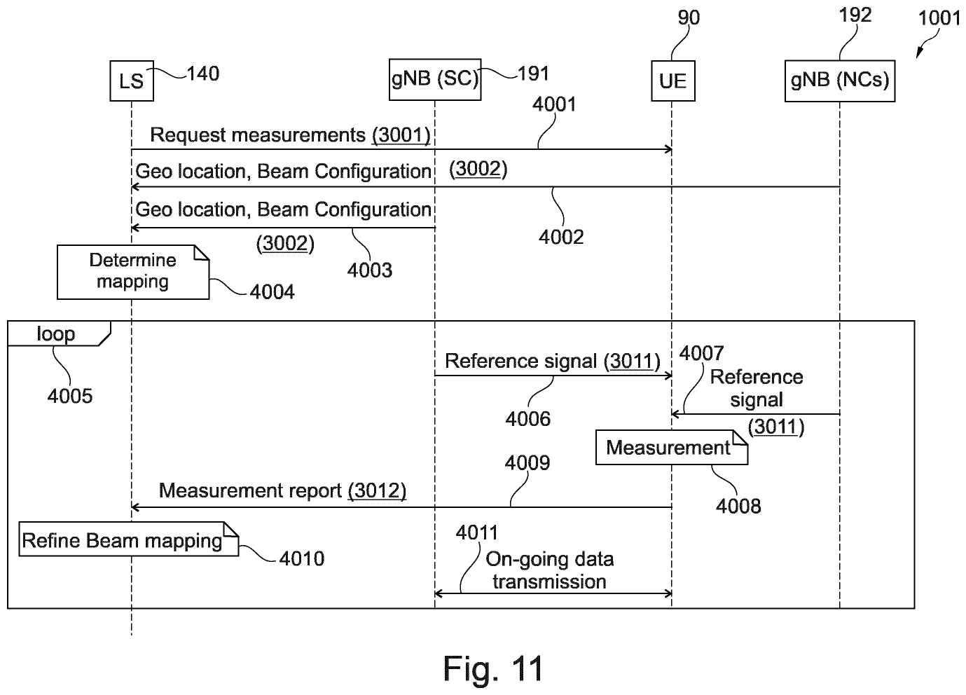

FIG. 11 is a signaling diagram of communication between the LS 140, the BS 191 of the serving cell (labelled the gNB according to the 3GPP 5G protocol), the UE 90, and the BS 192 of the neighboring cell (labelled gNB according to the 3GPP 5G protocol). FIG. 11 illustrates aspects with respect to the calibration of box 1001 (cf. FIG. 5 and FIG. 6).

At 4001, the LS 140 transmits a request message 3001 to the UE 90. The request message 3001 requests at the UE 90 to provide reference measurement reports.

For example, the request message 3001 could be indicative of a capability of the LS 140 to support determining of settings of neighboring-BS beams based on states of serving-BS beams and a predefined mapping.

The request message 3001 could alternatively or additionally also be provided to the serving BS 191 and/or the neighboring BS 192.

4001 may be executed as part of box 1011 (cf. FIG. 6).

At 4002, the BS 192 reports its geolocation and/or the configuration of its beams 71-78, e.g., orientation, maximum transmit power, etc. A corresponding control message 3002 is transmitted at 4002 and received by the LS 140.

At 4003, the respective control message 3002 is transmitted by the BS 191 and received by the LS 140.

At 4004, the LS then determines the mapping. 4004 may be executed as part of box 1011 (cf. FIG. 6).

This is based on the reported geo-locations of the BSs 191-192, as well as based on the reported beam configurations, is obtained from 4002-4003. For example, beam 3 of gNB1 (gNB1—b3) can be positively mapped to (gNB2—b8,b1,b2), (gNB3—b6,b7,b8), (gNB4—b4,b5,b6).

Next, the mapping is iteratively refined, by entering a loop 4005 (cf. FIG. 6: loop 1015). Here, at 4006, the BS 191 transmits a DL reference signal 3011 and the UE 90 receives the DL reference signal 3011. For example, the DL reference signal 3011 could be a DL PRS or another reference signal, e.g., a NZP-CSI-RS. The DL reference signal 3011 is transmitted in a reference transmission and on a corresponding reference beam of the reference transmission.

At 4007, the neighboring BS 192 also transmits the DL reference signal 3011 and the UE 90 receives the DL reference signal 3011. The DL reference signal 3011 is transmitted in a corresponding further reference transmission and on a corresponding further reference beam of the further reference transmission between the neighboring BS 192 and the UE 90.

It would be possible that 4006 and 4007 are executed substantially contemporaneously, i.e., during a time duration in which UE mobility is negligible, e.g., within a few tens or hundreds of milliseconds.

The UE 90, at 4008 makes reference measurements. This can be triggered by the request message 3001 of 4001. For example, one or more receive properties of the reference signals 3011 received at 4006 and 4007 could be determined.

At 4009, the UE 90 provides a pair of reference measurement reports 3012 to the LS 140. This can be triggered by the request message 3001 of 4001. The pair of reference measurement reports 3012 is indicative of the reference transmissions between the BS 191 and the UE 90, as well as the neighboring BS 192 and the UE 90, based on the measurement at 4008.

As a general rule, a similar approach can also be applied in case of UL positioning reference signal transmission (not shown in FIG. 11). Here, the UE transmits reference signal 3011 and the BSs 191, 192 perform measurement 4008 and measurement report 3012.

Then, at 4010, LS 140 refines the previously determined be mapping, based on the pair of measurement reports.

There can be an ongoing data transmission at 4011 between the serving BS 191 and the UE 90, e.g., to communicate payload data along the data connections 181-182 (cf. FIG. 1). This is generally optional.

The loop 4005 is reiterated, and multiple pairs of measurement reports 3012 are provided at the multiple iterations of 4009. The various pairs of measurement reports 3012 can be associated with different beams at the BS 191 and the BS 192; and/or with different neighboring BSs 192-195 (cf. FIG. 10; but not shown in FIG. 11).

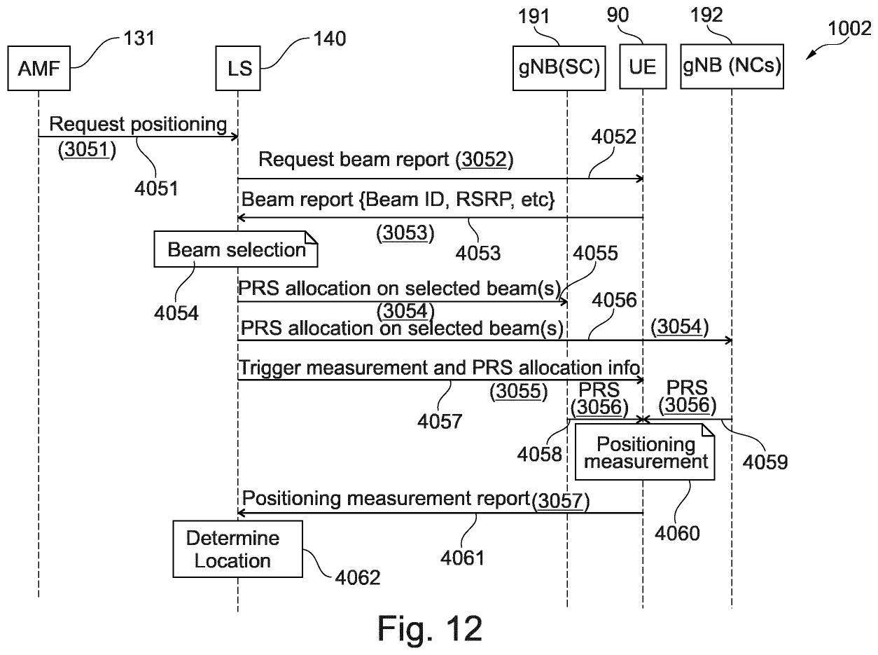

FIG. 12 is a signaling diagram of communication between the LS 140, the BS 191 of the serving cell (labelled the gNB according to the 3GPP 5G protocol), the UE 90, and the BS 192 of the neighboring cell (labelled gNB according to the 3GPP 5G protocol). FIG. 12 illustrates aspects with respect to the positioning of box 1002 (cf. FIG. 5 and FIG. 7).

As a general rule, while FIG. 12 illustrates a scenario in which DL PRSs are transmitted on TX beams of the BSs 191-192, similar techniques may be readily applied to UL PRSs received on RX beams of the BSs 191-192.

At 4051, the AMF 131 transmits a request 3051 for positioning to the LS 140. This may be to control a handover of the UE 90 between neighboring cells of the cellular network 100, or in response to an application-layer request.

Accordingly, at 4052, the LS 140 transmits a request 3052 for a beam report message 3053 to the UE 90. In some examples, alternatively or additionally to transmitting the request 3052 to the UE 90, it would also be possible to transmit the request 3052 to the serving BS 191.

In some examples, it would be possible that the request 3052 is indicative of a selection of a reduced reporting scheme (cf. FIG. 7: box 1021; FIG. 8: box 1031). The LS 140 may select the reduced reporting scheme in accordance with a capability and/or the availability of the mapping 51.

At 4053, the UE 90 provides a beam report message 3053 to the LS 140; this can be in accordance with the reduced reporting scheme. In the example of FIG. 12, the beam report message 3053 is indicative of only the beam IDs of the active beams 71-78 of the serving BS 191, and associated measurement reports of a transmission on these active beams 71-78, here in form of the RSRP. More generally speaking, the beam report message 3053 is indicative of a state of the serving-BS beams 71-78 of the transmission between the BS 191 and the UE 90.

As already outlined above, there are scenarios conceivable in which the beam report message 3053 is provided by the serving BS 191, alternatively or additionally to a beam report message 3053 provided by the UE 90.s

Based on the beam report message 3053 and the mapping 51, at 4054, the LS 140 then determines a state of the neighboring-BS beams 71-78 of the transmission between the neighboring BS 192 and the UE 90. For instance, the LS 140 could select the active beams for the transmission between the neighboring BS 192 and the UE 90. I.e., the LS 140 can determine whether a certain one of the neighboring-BS beams of the neighboring BS 192 is to be activated or deactivated.

At 4055, a control command 3054 to implement the transmission between the serving BS 191 and the UE 90 on one or more respective TX serving-BS beams 71-78 of this transmission is provided to the serving BS 191. The control command 3054 can be indicative, for each one of the serving-BS beams 71-78, whether the respective beam is activated (or deactivated). For instance, a respective activation bitmap could be included as information element, e.g., including a “1” for active beams and a “0” for deactivated beams. The control command 3054 can, alternatively or additionally, include an allocation of time-frequency resources for the DL PRSs, e.g. the DL PRSs to be transmitted by the serving BS 191. The resource allocation can be associated with the various serving-BS beams 71-78; i.e., different beams may or may not use different time-frequency resources (spatial multiplexing is possible). 4055 is optional.

At 4056, the respective control command 3054 to implement the transmission between the neighboring BS 192 and the UE 90 on one or more respective TX neighboring-BS beams 71-78 of this transmission is provided to the neighboring BS 192 (cf. FIG. 7: box 1024). I.e., the control command 3054 can be indicative, for each one of the neighboring-BS beams 71-78, of whether the respective beam is activated (or deactivated). For instance, a respective activation bitmap could be included as information element, e.g., including a “1” for active beams and a “0” for deactivated beams. The control command 3054 can include an allocation of time-frequency resources for the DL PRSs, e.g. the DL PRSs to be transmitted by the neighboring BS 192. The resource allocation can be associated with the various neighboring-BS beams 71-78; i.e., different beams may or may not use different time-frequency resources (spatial multiplexing is possible). The control command 3054 is in accordance with the state determined at 4054, e.g., indicative of the TX neighboring-BS beams 71-78 to be used by the neighboring BS 192 (i.e., whether a certain one of the TX neighboring-BS beams 71-78 is to be activated).

At 4057, a control command 3055 to trigger positioning measurements in accordance with the selected TX neighboring-BS beams 71-78 of the transmissions between the neighboring BS 192 and the UE 90 is provided to the UE 90. The control command 3055 can be indicative of the time-frequency resource allocations for the DL PRSs transmitted by the BS 191 and the BS 192.

The control command 3055 is aligned with the control command 3054.

Then, at 4058 and 4059, DL PRSs 3056 are transmitted by the serving BS 191 using the respective transmission and on the one or more serving-BS beams 71-78; DL PRSs are also transmitted by the neighboring BS 192 using the respective transmission and on the associated selected one or more neighboring-BS beam 71-78.

The UE 90 can then implement, at 4060, corresponding positioning measurements, i.e., determine one or more receive properties of the PRSs 3056.

Corresponding positioning measurement reports 3057 are provided to the LS 140 at 4061 (cf. FIG. 8: box 1034) and the LS 140 can determine the location of the UE 90 at 4062 based on the positioning measurement report 3057 (cf. FIG. 7: box 1025 and box 1026).

Summarizing, above, techniques have been described that facilitate an accurate and efficient positioning of a UE. For this, a mapping of beams of a first BS to other beams of one or more second BSs is determined, e.g., based on base-station geographical locations and/or beam configuration (direction/ID, Tx power, time of flight, angle of arrival, angle of departure) and/or UE beam reporting.

Then, the mapping is used for UE positioning, based on a reduced beam report that is restricted to the beams of the BS of the serving cell and Tx and/or RX power.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above, various examples have been described in which the mapping maps serving-BS beams of the serving BS to neighboring-BS beams of one or more neighboring BSs. According to various examples, it would be possible to parametrize the mapping: here, it would be possible that the mapping depends on one or more parameters such as the UE mobility or UE type or application type or on whether QCL is used or not. This can be, in particular, be helpful for non-line-of-sight scenarios.

For further illustration, above, various examples have been described in which the mapping is for mapping beams used for transmissions including PRSs. As a general rule, it would be possible to employ such mapping also for transmissions including other signals, e.g., other reference signals, e.g., synchronization signals, signals encoding payload data, etc.

For still further illustration, above, various examples have been described in connection with a cellular network. It would be possible that similar techniques are employed for a non-communication network, e.g., a positioning mesh network.

1. A method of operating a network node of a network, the network comprising a first access node and at least one second access node, the method comprising:
establishing a first state of one or more first beams of a first transmission between the first access node and a mobile device,
determining whether a certain one of one or more second beams of a second transmission between the at least one second access node and the mobile device is to be activated, based on the first state and a predetermined mapping between the first state and a second state of the one or more second beams, the second transmission comprising positioning reference signals.

2. The method of claim 1, wherein the first state of the one or more first beams is indicative of whether a certain one of the one or more first beams is activated or not.

3. The method of claim 1, wherein the first state of the one or more first beams is indicative of a measurement report for the first transmission on the one or more first beams.

4. The method of claim 1, wherein the first state of the one or more first beams is established based on at least one beam report message provided by at least one of the first access node or the mobile device.

5. The method of claim 4, further comprising:
selecting a reporting scheme from a plurality of reporting schemes for providing the at least one beam report message at the mobile device, and
obtaining the beam report message in accordance with the reporting scheme.

6. The method of claim 5, wherein the selected reporting scheme is restricted to providing the at least one beam report message comprising the first state of the one or more first beams, wherein a further reporting scheme of the plurality of reporting schemes comprises providing the at least one beam report message comprising the first state of the one or more first beams and comprising the second state of the one or more second beams.

7. The method of claim 1, further comprising:
determining the mapping based on geolocations of the first access node and the at least one second access node.

8. The method of claim 1, further comprising:
determining the mapping based on a configuration of at least one of the one or more first beams or the one or more second beams.

9. The method of claim 8, wherein the configuration comprises one or more of the following: a beam direction; a transmission power threshold; an angle of arrival; or an angle of departure.

10. The method of claim 1, further comprising:
determining the mapping based on pairs of reference measurement reports for reference transmissions on multiple first reference beams and between the first access node and the mobile device, as well as for further reference transmissions on multiple second reference beams and between the at least one second access node and the mobile device.

11. The method of claim 10, wherein said determining of the mapping further comprises:
iteratively refining the mapping based on multiple instances of the reference measurement reports and further measurement reports.

12. The method of claim 1, wherein the second transmission comprises downlink positioning reference signals transmitted from the at least one second access node on the one or more second beams, and/or wherein the second transmission comprises uplink positioning reference signals received by the at least one second access node on the one or more second beams.

13. The method of claim 1, further comprising:
providing at least one control command to at least one of the at least one second access node or the mobile device, the control command being indicative of whether the certain one of the one or more second beams is to be activated and/or time-frequency resources allocated to the second transmission.

14. The method of claim 1, wherein the network node is a location server of the network.

15. The method of claim 1, wherein the first access node is a serving access node of the mobile device.

16. The method of claim 1, wherein the predetermined mapping comprises at least one of a look-up table, a parameterized dependency, and a machine-learning algorithm.

17. The method of claim 1, wherein the predetermined mapping depends on at least one of a configuration of at least one of the one or more first beams or the one or more second beams, a geolocation of the mobile device, or a mobility of the mobile device.

18. A method of operating a mobile device served by a first access node of a network, the network comprising the first access node and at least one second access node, the method comprising:
activating a reporting scheme selected from a plurality of reporting schemes for providing at least one beam report message, the at least one beam report message comprising a state of one or more first beams of a first transmission between the first access node and a mobile device, and
providing the at least one beam report message in accordance with the reporting scheme.

19. The method of claim 18, wherein the reporting scheme is restricted to providing the at least one beam report message comprising the state of the one or more first beams, wherein a further reporting scheme of the plurality of reporting schemes comprises providing the at least one beam report message comprising the state of the one or more first beams and further comprising a further state of one or more second beams of a second transmission between the mobile device and the at least one second access node.

20. A method of operating a mobile device served by a first access node of a network, the network comprising the first access node and at least one second access node, the method comprising:
obtaining a control command from a location server of the network, the control command being indicative of whether a certain one of one or more second beams of a second transmission between the at least one second access node and the mobile device is to be activated and/or time-frequency resources allocated to the second transmission.

21-30. (canceled)
